(19) United States
(12) Patent Application Publication
(10) Pub. No.: US 2016/0042055 A1
(43) Pub. Date: Feb. 11, 2016

(54) METHOD AND DEVICE FOR ESTABLISHING LABEL LIBRARY AND SEARCHING FOR USER

(71) Applicant: Xiaomi Inc., Beijing (CN)

(72) Inventors: Jie XIANG, Beijing (CN); Runchao LI, Beijing (CN); Tao QIN, Beijing (CN)

(73) Assignee: Xiaomi Inc.

(21) Appl. No.: 14/886,267

(22) Filed: Oct. 19, 2015

Related U.S. Application Data
(63) Continuation of application No. PCT/CN2014/076042, filed on Apr. 23, 2014.

(30) Foreign Application Priority Data
Aug. 2, 2013 (CN) 201310334335.2

(51) Int. Cl. G06F 17/30

(52) U.S. Cl. CPC G06F 17/30598; G06F 17/30867

(57) ABSTRACT

A method for establishing a label library includes receiving label information made by a labeling user regarding a labeled user in a social network, storing the labeling user, the labeled user, and the label information as a relationship, and establishing a label library based on the relationship.

### CROSS-REFERENCE TO RELATED APPLICATIONS

This application is a continuation of International Application No. PCT/CN2014/076042, filed Apr. 23, 2014, which is based upon and claims priority to Chinese Patent Application No. CN201310334335.2, filed Aug. 2, 2013, the entire contents of both of which are incorporated herein by reference.

### TECHNICAL FIELD

The present disclosure relates to computer and communication technology and, more particularly, to a method and device for establishing a label library, and a method and device for searching for a user.

### BACKGROUND

With the development of the social networking service (SNS), Internet has been extended from an application platform for research institutes, schools, governments, and businesses to a social communication tool for ordinary people to meet their social demands, taking the place of traditional social interaction. The SNS, based on the principle of “low substitute cost,” reduces time and costs in social interaction, i.e., reduces costs in information management and transfer. With the SNS, it has become possible to send and receive emails to and from friends thousands of miles away, complete a project with them and enjoy entertainments together. In addition to that, a user can search for other users in the SNS and add them to a contact list. As such, the user can make new friends and expand his/her personal relationship and social communication circle.

At present, when searching for a contact according to a specific condition in the SNS, a user normally searches in his direct contact list or in the whole social network.

### SUMMARY

In accordance with the present disclosure, there is provided a method for establishing a label library. The method includes receiving label information made by a labeling user regarding a labeled user in a social network, storing the labeling user, the labeled user, and the label information as a relationship, and establishing a label library based on the relationship.

Also in accordance with the present disclosure, there is provided a method for searching for a user. The method includes receiving a search request sent to a label library. The search request includes a search initiator and a search keyword, and the label library includes at least one relationship. Each of the at least one relationship includes a labeling user, a labeled user, and label information made by the labeling user regarding the labeled user. The method further includes determining at least one contact of a predetermined level of the search initiator, searching for matched label information matching the search keyword among label information in the label library that has the at least one contact as a labeling user, and returning the matched label information.

Also in accordance with the present disclosure, there is provided a device for establishing a label library. The device includes a processor and a non-transitory computer-readable storage medium storing instructions. The instructions, when executed by the processor, cause the processor to receive label information made by a labeling user regarding a labeled user in a social network, store the labeling user, the labeled user, and the label information as a relationship, and establish a label library based on the relationship.

Also in accordance with the present disclosure, there is provided a device for searching for a user. The device includes a processor and a non-transitory computer-readable storage medium storing instructions. The instructions, when executed by the processor, cause the processor to receive a search request sent to a label library. The search request includes a search initiator and a search keyword, and the label library includes at least one relationship. Each of the at least one relationship includes a labeling user, a labeled user, and label information made by the labeling user regarding the labeled user. The instructions further cause the processor to determine at least one contact of a predetermined level of the search initiator based on the at least one relationship, search for matched label information matching the search keyword among label information in the label library that has the at least one contact as a labeling user, and return the matched label information.

It is to be understood that both the foregoing general description and the following detailed description are exemplary and explanatory only and are not restrictive of the invention, as claimed.

Hereinafter, a further detailed description will be given to the technical solutions of the embodiments of the disclosure with reference to the accompanied drawings and the embodiments.

### BRIEF DESCRIPTION OF THE DRAWINGS

The accompanying drawings, for further understanding of the embodiments of the present disclosure, constitute a part of this specification, together with the embodiments of the disclosure, serve to explain the present disclosure, and should not constitute limitation to the embodiments of the disclosure. In the drawings:

FIG. 1 is a flowchart of a method for establishing a label library according to an exemplary embodiment of the present disclosure.

FIG. 2 is a flowchart of a method for making a label according to another exemplary embodiment of the present disclosure.

FIG. 3 is a flowchart of a method for making a label according to another exemplary embodiment of the present disclosure.

FIG. 4 is a flowchart of a method for making a label according to another exemplary embodiment of the present disclosure.

FIG. 5 is a flowchart of a method for making a label according to another exemplary embodiment of the present disclosure.

FIG. 6 is a flowchart of a method for making a label according to another embodiment of the present disclosure.

FIG. 7 is a flowchart of a method for searching for a user with a label library according to an exemplary embodiment of the present disclosure.

FIG. 8 is a flowchart showing an example of implementing methods for searching for a user according to the present disclosure.

FIG. 9 is a flowchart showing another example of implementing methods for searching for a user according to the present disclosure.

FIG. 10 is a flowchart showing an example of implementing methods for establishing a user relationship with a found user according to the present disclosure.

FIG. 11 is a block diagram of a device for establishing a label library according to an exemplary embodiment of the present disclosure.

FIG. 12 is a block diagram of a device for establishing a label library according to another exemplary embodiment of the present disclosure.

FIG. 13 is a block diagram of a device for establishing a label library according to another exemplary embodiment of the present disclosure.

FIG. 14 is a block diagram of a device for establishing a label library according to another exemplary embodiment of the present disclosure.

FIG. 15 is a block diagram of a device for establishing a label library according to another exemplary embodiment of the present disclosure.

FIG. 16 is a block diagram of a device for establishing a label library according to another exemplary embodiment of the present disclosure.

FIG. 17 is a block diagram of a device for searching for a user according to an exemplary embodiment of the present disclosure.

FIG. 18 is a block diagram of a device for searching for a user according to another exemplary embodiment of the present disclosure.

FIG. 19 is a block diagram of an apparatus according to an exemplary embodiment of the present disclosure.

Through the above accompany drawings, the specific embodiments of the present disclosure have been shown, for which a more detailed description will be given below. These drawings and textual description are not intended to limit the scope of the concept of the present disclosure in any manner, but to explain the concept of the present disclosure to those skilled in the art through particular embodiments.

### DETAILED DESCRIPTION

Embodiments of the present disclosure are described below with reference to the attached drawings. However, it should be understood that the embodiments described herein are merely for explaining and illustrating the present disclosure, but are not intended to limit the scope of the present disclosure. Methods for establishing a label library and for searching for a user according to the embodiments of the present disclosure can be implemented, for example, in a server that provides social networking services.

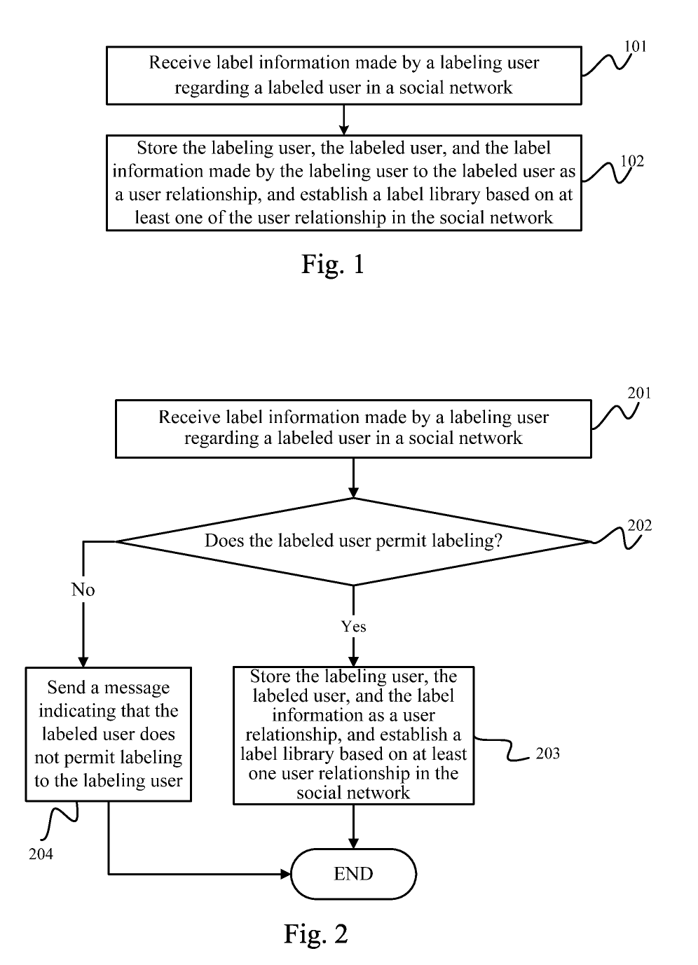

FIG. 1 shows a method for establishing a label library according to an exemplary embodiment of the present disclosure. As shown in FIG. 1, at S101, label information made by a labeling user regarding a labeled user in a social network is received. In some embodiments, the label information includes one or more items of information of the labeled user: occupation, skill, interest, adored celebrity, working state (such as looking for a job or hiring), personal life state (for example, single), and the like.

At S102, the labeling user, the labeled user, and the label information are stored as a user relationship, and the label library is established based on at least one user relationship in the social network. In some embodiments, a validity period of the label information may also be acquired. The labeling user, the labeled user, the label information, and the validity period of the label information are stored as a user relationship. When the label information expires at the end of the validity period, the labeling user, the labeled user, and the label information related to the validity period are deleted from the label library. The validity period can be defined by the labeling user, by the labeled user, or by a system implementing the method of the present disclosure.

According to the present disclosure, a search for a contact is based on both the label information and the user relationship, where the user that is located has an indirect relationship with the searching user. Therefore, the user that is located is more reliable, and the success rate of the search can be improved.

FIG. 2 shows a method according to another exemplary embodiment of the present disclosure. The method shown in FIG. 2 can prevent a user from being arbitrarily labeled by other users. Specifically, as shown in FIG. 2, at S201, label information made by a labeling user regarding a labeled user in a social network is received.

At S202, it is judged whether the labeled user permits labeling. If the labeled user permits labeling, the process proceeds to S203. Otherwise, the process proceeds to S204.

For example, whether the labeled user permits labeling can be judged by reading a value of a field “Whether permit labeling” defined by the labeled user in data regarding the labeled user. A value of “Yes” in this field indicates that the labeled user permits labeling. On the other hand, a value of “No” in this field indicates that the labeled user does not permit labeling.

At S203, the labeling user, the labeled user, and the label information are stored as a user relationship, and the label library is established based on at least one user relationship in the social network.

At S204, a message indicating that the labeled user does not permit labeling is sent to the labeling user.

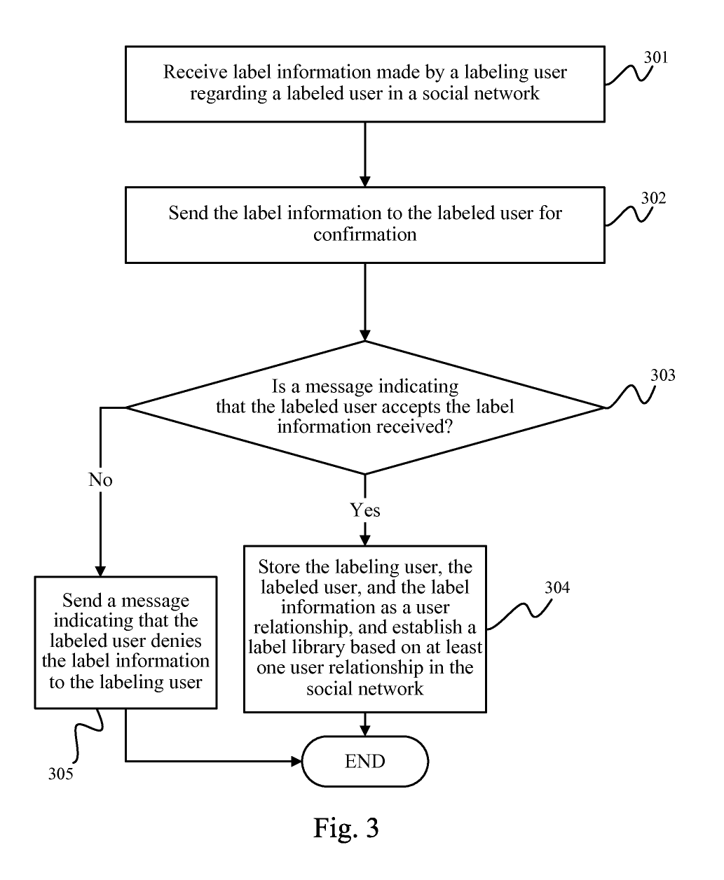

FIG. 3 shows a method according to another exemplary embodiment of the present disclosure. As shown in FIG. 3, at S301, label information made by a labeling user regarding a labeled user in a social network is received.

At S302, the label information is sent to the labeled user for confirmation.

At S303, it is judged whether a message indicating that the labeled user accepts the label information is received. If such a message is received, the process proceeds to S304. If no such a message is received, the process proceeds to S305.

At S304, the labeling user, the labeled user, and the label information are stored as a user relationship, and the label library is established based on at least one user relationship in the social network.

At S305, a message indicating that the labeled user denies the label information is sent to the labeling user.

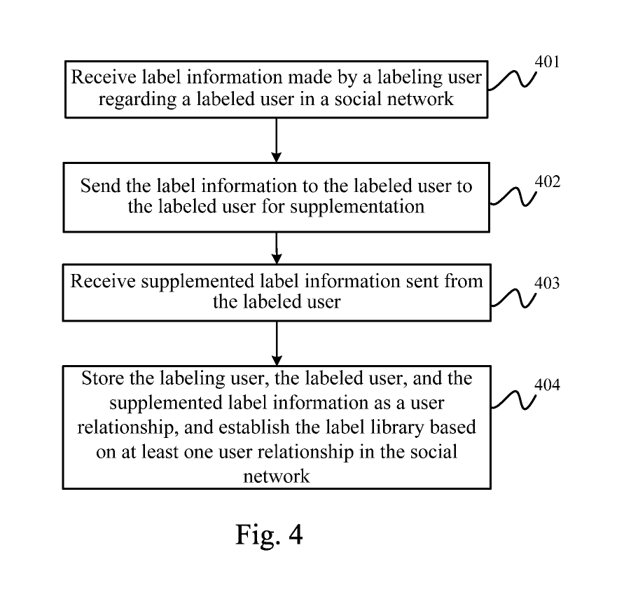

FIG. 4 shows a method according to another exemplary embodiment of the present disclosure. As shown in FIG. 4, at S401, label information made by a labeling user regarding a labeled user in a social network is received.

At S402, the label information made by the labeling user to the labeled user is sent to the labeled user for supplementation. For example, if the labeling user has labeled the labeled user as a software engineer in the label information, then the labeled the user can supplement the label information to add programming languages that the labeled user knows and related development skills.

At S403, the supplemented label information sent from the labeled user is received.

At S404, the labeling user, the labeled user, and the supplemented label information are stored as a user relationship, and the label library is established based on at least one user relationship in the social network.

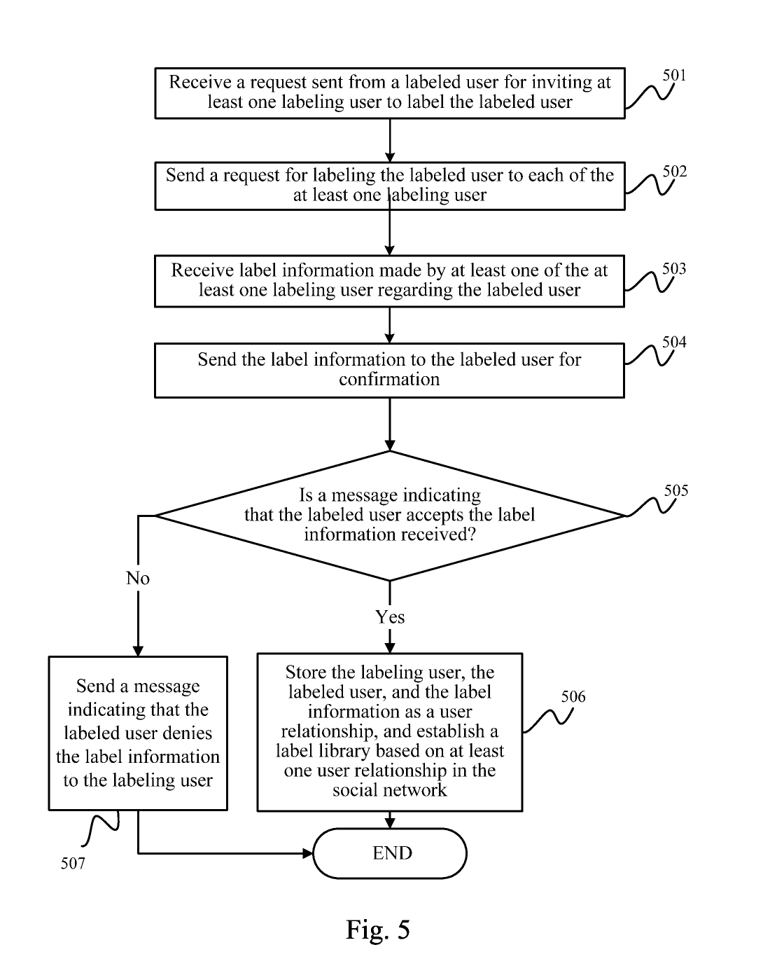

FIG. 5 shows a method according to another exemplary embodiment of the present disclosure. As shown in FIG. 5, at S501, a request sent from a labeled user for inviting at least one labeling user to label the labeled user is received.

At S502, a request for labeling the labeled user is sent to each of the at least one labeling user.

At S503, label information made by at least one of the at least one labeling user regarding the labeled user is received.

At S504, the label information is sent to the labeled user for confirmation.

At S505, it is judged whether a message indicating that the labeled user accepts the label information is received. If such a message is received, the process proceeds to S506. If no such message is received, the process proceeds to S507.

At S506, the labeling user, the labeled user, and the label information are stored as a user relationship, and a label library is established based on at least one user relationship in the social network.

At S507, a message indicating that the labeled user denies the label information is sent to the labeling user.

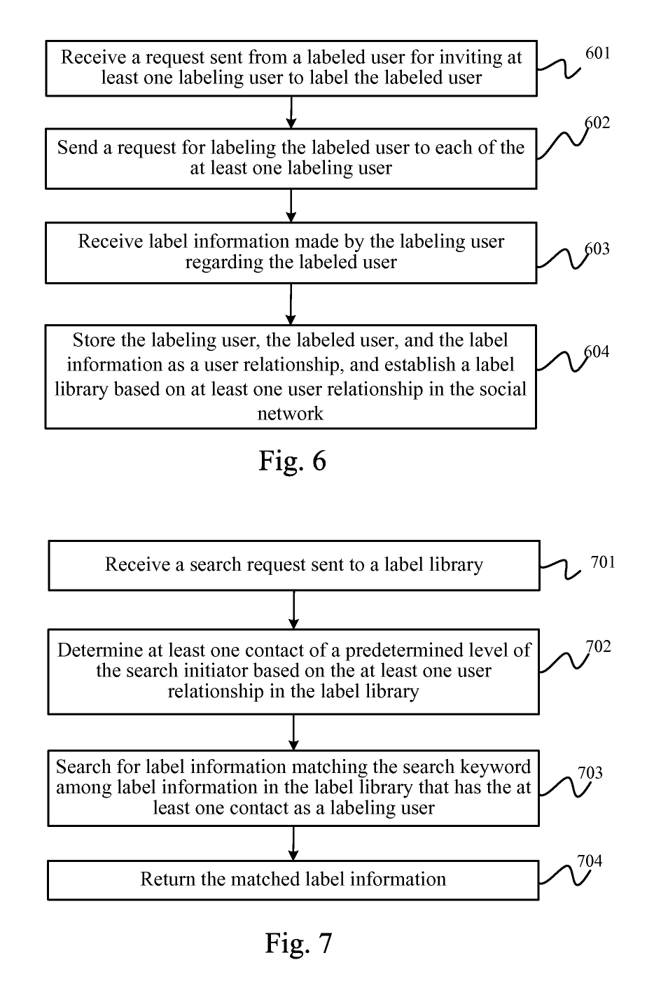

FIG. 6 shows a method according to another exemplary embodiment of the present disclosure. As shown in FIG. 6, at S601, a request sent from a labeled user for inviting at least one labeling user to label the labeled user is received. The request includes first label information made by the labeled user regarding himself or herself.

At S602, a request for labeling the labeled user is sent to each of the at least one labeling user. The request includes the first label information.

At S603, second label information made by the labeling user regarding the labeled user is received. In some embodiments, if the labeling user makes no changes, the first label information is identical to the second label information.

At S604, the labeling user, the labeled user, and the second label information are stored as a user relationship, and a label library is established based on at least one user relationship in the social network.

FIG. 7 shows a method according to another exemplary embodiment of the present disclosure. As shown in FIG. 7, at S701, a search request sent to a label library is received. The search request includes at least a search initiator and a search keyword. The label library is established based on at least one user relationship in a social network in which a labeling user, a labeled user, and label information made by the labeling user regarding the labeled user are stored as a user relationship.

At S702, based on the at least one user relationship in the label library, at least one contact of a predetermined level of the search initiator is determined. Each of the at least one contact of the predetermined level is a contact having a user relationship with the search initiator within the predetermined level based on the at least one user relationship. For example, User B is User A's friend and thus is a first-level contact of User A. User C is not a first-level contact of User A but is a friend of User B, so that User C is a second-level contact of User A. User D is neither a first-level contact nor a second-level contact of User A, but is a friend of User C, so that User D is a third-level contact of User A. The predetermined level can be set by the search initiator or by the system.

At S703, label information in the label library that has the at least one contact as a labeling user is searched to determine the label information matching the search keyword.

At S704, the matched label information that is located by the searching is returned.

In some embodiments, based on the at least one user relationship in the label library, a user relationship among the search initiator, a labeling user associated with the matched label information, and a labeled user associated with the matched label information can be acquired. The acquired user relationship is sent to the search initiator and/or the labeled user associated with the matched label information. For example, User A finds User C, who is a second-level contact u of User A, by searching for the label made by User B, who is a first-level contact of User A. Hence the user relationship among User A, User B, and User C is that User A finds User C, who is a labeled user, via User B.

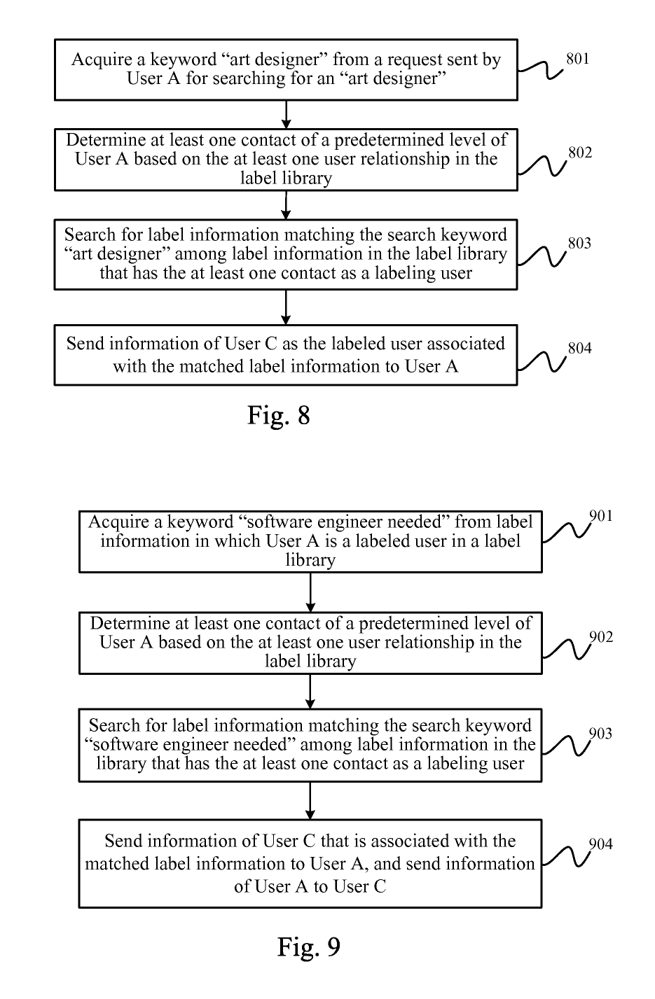

FIG. 8 shows an example of implementing methods consistent with embodiments of the present disclosure. As shown in FIG. 8, at S801, a keyword “art designer” is acquired from a request sent by User A for searching for an “art designer.”

At S802, at least one contact of a predetermined level of User A is determined based on the at least one user relationship in the label library.

At S803, label information in the label library that has the at least one contact as a labeling user is searched for label information matching the search keyword “art designer.”

At S804, information of User C as the labeled user that is related to the matched label information is sent to User A.

For example, User B is a first-level contact of User A. The label information made by User B regarding User C is “art designer.” Assume User A needs an art designer, but does not know User C. User A can find User C with the label “art designer” made by User B.

FIG. 9 shows another example of implementing methods consistent with embodiments of the present disclosure. As shown in FIG. 9, at S901, a keyword “software engineer needed” is acquired from label information in which User A is a labeled user in a label library.

At S902, at least one contact of a predetermined level of User A is determined based on the at least one user relationship in the label library.

At S903, label information in the label library that has the at least one contact as a labeling user is searched to determine the label information matching the search keyword “software engineer needed.” For example, labels matching the keyword “software engineer needed” may be “I am a software engineer,” “Engaged in software engineering,” “Software engineer,” “IT worker,” or the like.

At S904, information of the labeled user, e.g., User C, which is associated with the matched label information, is sent to User A, and information of User A is sent to User C. In some embodiments, only information of User C is sent to User A, or only information of User A is sent to User C.

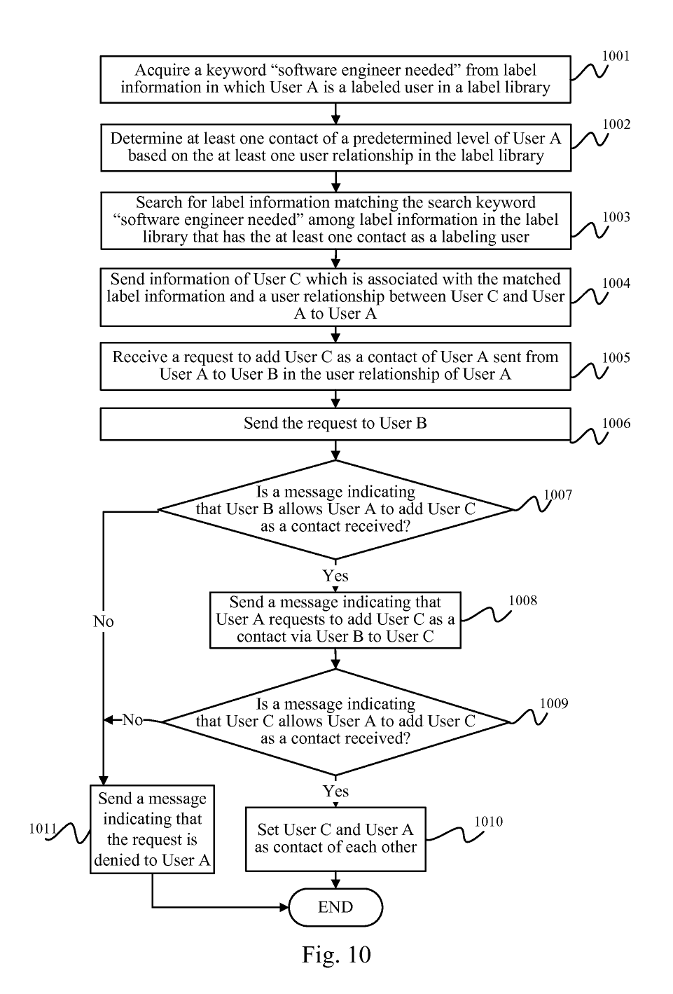

FIG. 10 shows another example of implementing methods consistent with embodiments of the present disclosure. As shown in FIG. 10, at S1001, a keyword “software engineer needed” is acquired from label information in which User A is a labeled user in a label library.

At S1002, at least one contact of a predetermined level of User A is determined based on the at least one user relationship in the label library.

At S1003, label information in the library that has the at least one contact as a labeling user is searched to determine the label information matching the search keyword “software engineer needed.”

At S1004, information of the labeled user, e.g., User C, which is associated with the matched label information, and a user relationship between User C and User A are sent to User A. In some embodiments, the user relationship between User C and User A can also be sent to User C to ensure that User C timely becomes aware of other users whose label information matches User C's label information.

At S1005, a request to add User C as a contact of User A sent from User A to User B in the user relationship of User A is received.

At S1006, the request is sent to User B.

At S1007, it is judged whether a message indicating that User B allows User A to add User C as a contact is received. If such a message is received, the process proceeds to S1008. If no such message is received, the process proceeds to S1011.

At S1008, a message indicating that User A requests to add User C as a contact via user B is sent to User C.

At S1009, it is judged whether a message indicating that User C allows User A to add User C as a contact is received. If such a message is received, the process proceeds to S1010. If no such message is received, the process proceeds to S1011.

At S1010, User C and User A are set as contact of each other.

At S1011, a message indicating that the request is denied is sent to User A.

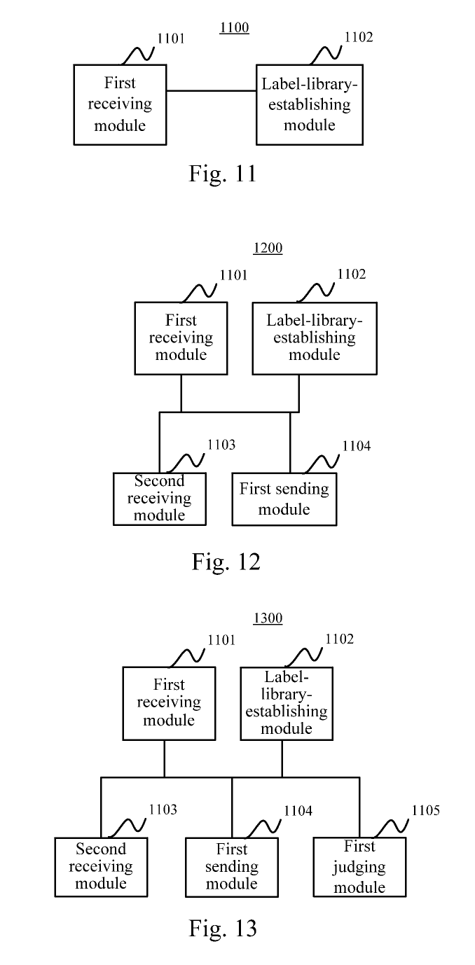

FIG. 11 shows an exemplary device 1100 for establishing a label library consistent with embodiments of the present disclosure. As shown in FIG. 11, the device 1100 includes a first receiving module 1101 and a label-library-establishing module 1102. The first receiving module 1101 is configured to receive label information made by a labeling user regarding a labeled user in a social network. In some embodiments, the label information includes one or more items of information of the labeled user: occupation, skill, interest, adored celebrity, working state (such as looking for a job or hiring), personal life state (for example, single), and the like. The label-library-establishing module 1102 is configured to store the labeling user, the labeled user, and the label information as a user relationship, and to establish a label library based on at least one user relationship in the social network.

FIG. 12 shows another exemplary device 1200 consistent with embodiments of the present disclosure. The device 1200 is similar to the device 1100, except that the device 1200 further includes a second receiving module 1103 and a first sending module 1104. The second receiving module 1103 is configured to receive a request sent from the labeled user for inviting at least one labeling user to label the labeled user. The first sending module 1104 is configured to send a request for labeling the labeled user to each of the at least one labeling user.

In some embodiments, the request sent from the labeled user for inviting the at least one labeling user to label the labeled user includes label information made by the labeled user regarding himself or herself. The request for labeling the labeled user sent to each of the at least one labeling user also includes the label information made by the labeled user regarding himself or herself.

FIG. 13 shows another exemplary device 1300 consistent with embodiments of the present disclosure. The device 1300 is similar to the device 1200, except that the device 1300 further includes a first judging module 1105 configured to judge whether the labeled user permits labeling. If the labeled user permits labeling, the label-library-establishing module 1102 stores the labeling user, the labeled user, and the label information made by the labeling user regarding the labeled user as a user relationship, and establishes the label library based on at least one user relationship in the social network.

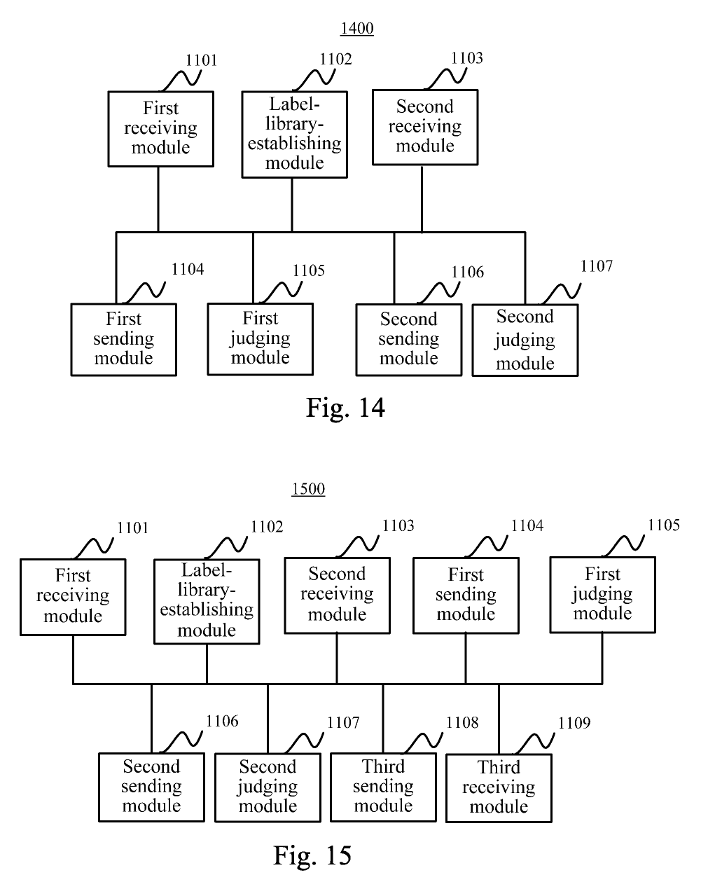

FIG. 14 shows another exemplary device 1400 consistent with embodiments of the present disclosure. The device 1400 is similar to the device 1300, except that the device 1400 further includes a second sending module 1106 and a second judging module 1107. The second sending module 1106 is configured to send the label information made by the labeling user regarding the labeled user to the labeled user for confirmation. The second judging module 1107 is configured to judge whether a message indicating that the labeled user accepts the label information is received. If such a message is received, the label-library-establishing module 1102 stores the labeling user, the labeled user, and the label information made by the labeling user regarding the labeled user as a user relationship, and establishes the label library based on at least one user relationship in the social network.

FIG. 15 shows another exemplary device 1500 consistent with embodiments of the present disclosure. The device 1500 is similar to the device 1400, except that the device 1500 further includes a third sending module 1108 and a third receiving module 1109. The third sending module 1108 is configured to send the label information made by the labeling user regarding the labeled user to the labeled user for supplementation. The third receiving module 1109 is configured to receive the label information supplemented by the labeled user. The label-library-establishing module 1102 is further configured to store the labeling user, the labeled user, and the supplemented label information as a user relationship, and establish the label library based on at least one user relationship in the social network.

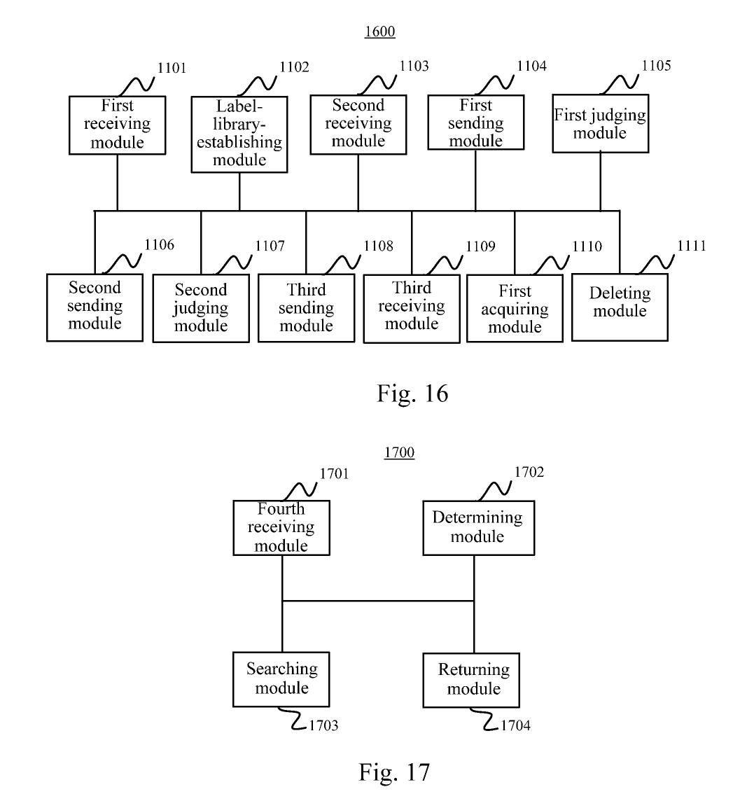

FIG. 16 shows another exemplary device 1600 consistent with embodiments of the present disclosure. The device 1600 is similar to the device 1500, except that the device 1600 further includes a first acquiring module 1110 and a deleting module 1111. The first acquiring module 1110 is configured to acquire a validity period of the label information made by the labeling user regarding the labeled user. The label-library-establishing module 1102 is further configured to store the labeling user, the labeled user, the label information made by the labeling user regarding the labeled user, and the validity period of the label information as a user relationship, and establish the label library based on at least one user relationship in the social network. When the validity period of the label information expires, the deleting module 1111 deletes the labeling user, the labeled user, and the label information made by the labeling user regarding the labeled user associated with the validity period of the label information from the label library.

FIG. 17 shows an exemplary device 1700 for searching for a user consistent with embodiments of the present disclosure. The device 1700 includes a fourth receiving module 1701, a determining module 1702, a searching module 1703, and a returning module 1704. The fourth receiving module 1701 is configured to receive a search request sent to a label library, which is established based on at least one user relationship in a social network in which a labeling user, a labeled user, and label information made by the labeling user regarding the labeled user are stored as a user relationship. The search request includes at least a search initiator and a search keyword. The determining module 1702 is configured to determine at least one contact of a predetermined level of the search initiator based on the at least one user relationship in the label library. Each of the at least one contact of the predetermined level is a contact having a user relationship with the search initiator within the predetermined level based on the at least one user relationship. The searching module 1703 is configured to search for label information matching the search keyword among label information related to the at least one contact as a labeling user in the label library. The returning module 1704 is configured to return the matched label information.

In some embodiments, the search request is sent by the search initiator to the label library and the returning module 1704 is further configured to send information of a labeled user associated with the matched label information to the search initiator.

In some embodiments, the search request is a search request in which the search initiator is a labeled user associated with a piece of label information in the label library, and the search keyword is acquired from the piece of label information. In this scenario, the returning module 1704 is further configured to send the matched label information to the search initiator and/or a labeled user associated with the matched label information.

In some embodiments, the predetermined level is set by the search initiator or in default.

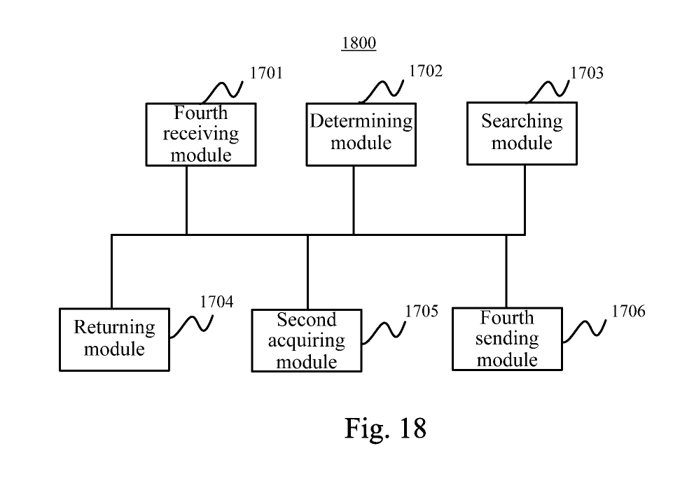

FIG. 18 shows another exemplary device 1800 consistent with embodiments of the present disclosure. The device 1800 is similar to the device 1700, except that the device 1800 further includes a second acquiring module 1705 and a fourth sending module 1706. The second acquiring module 1705 is configured to acquire a user relationship between the search initiator and a labeling user associated with the matched label information, and a user relationship between the search initiator and a labeled user associated with the matched label information, based on the at least one user relationship in the label library. The fourth sending module 1706 is configured to send the acquired user relationships to the search initiator and/or the labeled user associated with the matched label information.

Other features and advantages of embodiments of the present disclosure will be set forth in the following description. Moreover, it will become apparent from the present disclosure, or be understood by implementing the present disclosure. Advantages of the present disclosure may be realized and achieved by structures specially specified in the description, the claims, and the accompanied drawings.

It should be understood by those skilled in the art that the embodiments of the present disclosure may be provided as methods, devices, or computer program products. Therefore, the embodiments of the present disclosure may take forms of embodiments of mere hardware, mere software, or a combination of software and hardware. Furthermore, the present disclosure may take forms of computer program products executed on one or more non-transitory computer-readable storage media (including but not limited to disk storage, CD-ROM and optical storage, etc.) containing computer-readable program codes.

The present disclosure is described with reference to flowcharts and/or block diagrams of the method, the mobile device (system) and a computer program product according to the embodiments of the present disclosure. It should be understood that each process and/or block in the flowcharts and/or block diagrams, and combinations of processes and/or blocks in the flowcharts and/or block diagrams, may be realized by computer program instructions. These computer program instructions may be supplied to a general-purpose computer, a special-purpose computer, an embedded processor, or processors of other programmable data processing devices, to create a machine, such that a device for realizing functions designated in one or more processes in the flowcharts and/or in one or more blocks in the block diagrams, may be produced by instructions performed by a computer or processors of other programmable data processing devices.

These computer program instructions may also be stored in a computer readable storage that can boot a computer or other programmable data processing devices to operate in a specific way, such that a manufactured articles including an instruction device may be produced by the instructions stored in said computer readable storage, and said instruction device realizes the functions designated in one or more processes in the flowcharts and/or in one or more blocks in the block diagrams.

These computer program instructions may further be loaded into a computer or other programmable data processing devices, such that a series of operating steps may be performed on the computer or other programmable data processing devices, so as to generate processes realized by the computer, such that steps for realizing the functions designated in one or more processes in the flowcharts and/or in one or more blocks in the block diagrams may be provided by the instructions executed on the computer or other programmable data processing devices.

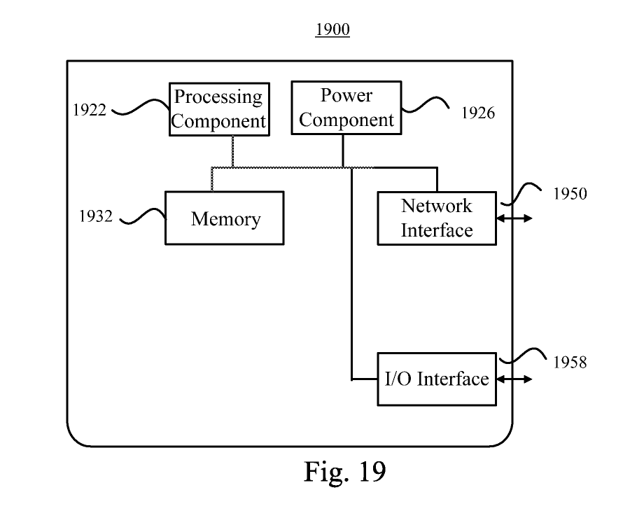

For example, FIG. 19 is a block diagram illustrating an apparatus 1900 according to an exemplary embodiment of the present disclosure. For example, the apparatus 1900 may be provided as a server. As shown in FIG. 19, the apparatus 1900 includes a processing component 1922, which further includes one or more processors; and memory resources represented by a memory 1932, configured to store instructions executable by the processing component 1922, for example, applications. The memory 1932 may be a non-transitory computer-readable storage medium. The applications stored in the memory 1932 may include one or more modules each corresponding to a group of instructions. In addition, the processing component 1922 is configured to execute the instructions, such as those stored in the memory 1932, to perform label library establishing and/or user searching methods consistent with embodiments of the present disclosure.

In some embodiments, as shown in FIG. 19, the apparatus 1900 further includes a power component 1926, configured to perform power management in the apparatus 1900; a wired or wireless network interface 1950, configured to connect the apparatus 1900 to a network; and an input/output (I/O) interface 1958. The apparatus 1900 may operate an operating system stored in the memory 1932, for example, Windows Server™, Mac OS X™, Unix™, Linux™, FreeBSD™, or the like.

Those skilled in the art may make various modifications and variations to the present disclosure without departing from the spirit and scope of the disclosure. Thus, the disclosure intends to include those modifications and variations as long as they are consistent with the scope of the claims of the present disclosure and the equivalent technology thereof.

What is claimed is:

1. A method for establishing a label library, comprising:
receiving label information made by a labeling user regarding a labeled user in a social network;
storing the labeling user, the labeled user, and the label information as a relationship; and
establishing a label library based on the relationship.

2. The method according to claim 1, further comprising, before receiving the label information:
receiving a first request sent from the labeled user for inviting the labeling user to label the labeled user; and
sending a second request for labeling the labeled user to the labeling user.

3. The method according to claim 2, wherein:
the label information made by the labeling user regarding the labeled user is first label information,
receiving the first request includes receiving the first request including second label information made by the labeled user regarding the labeled user, and
sending the second request includes sending the second request including the second label information.

4. The method according to claim 1, further comprising, after receiving the label information:
judging whether the labeled user permits labeling,
wherein storing the labeling user, the labeled user, and the label information, and establishing the label library includes storing the labeling user, the labeled user, and the label information, and establishing the label library, if the labeled user permits labeling.

5. The method according to claim 1, further comprising, after receiving the label information:
sending the label information to the labeled user for confirmation; and
judging whether a message indicating that the labeled user accepts the label information is received,
wherein storing the labeling user, the labeled user, and the label information, and establishing the label library includes storing the labeling user, the labeled user, and the label information, and establishing the label library, if the message is received.

6. The method according to claim 1, further comprising, after receiving label information:
sending the label information to the labeled user for supplementation; and
receiving supplemented label information sent by the labeled user,
wherein storing the labeling user, the labeled user, and the label information includes storing the labeling user, the labeled user, and the supplemented label information as the relationship.

7. The method according to claim 1, further comprising:
acquiring a validity period of the label information;
wherein:
storing the labeling user, the labeled user, and the label information includes storing the labeling user, the labeled user, the label information, and the validity period as the relationship, and
the method further includes deleting, when the label information expires according to the validity period, the labeling user, the labeled user, and the label information from the label library.

8. A method for searching for a user, comprising:
receiving a search request sent to a label library, the search request including a search initiator and a search keyword, and the label library includes at least one relationship, each of the at least one relationship including a labeling user, a labeled user, and label information made by the labeling user regarding the labeled user;
determining, based on the at least one relationship, at least one contact of a predetermined level of the search initiator;
searching for matched label information matching the search keyword among label information in the label library that has the at least one contact as a labeling user; and
returning the matched label information.

9. The method according to claim 8, wherein:
receiving a search request includes receiving the search request sent by the search initiator to the label library, and
returning the matched label information includes sending information of a labeled user associated with the matched label information to the search initiator.

10. The method according to claim 8, wherein:
the search initiator is a labeled user associated with a piece of label information in the label library,
receiving the search request further includes acquiring the search keyword from the piece of label information, and
returning the matched label information includes sending the matched label information to at least one of the search initiator or a labeled user associated with the matched label information.

11. The method according to claim 8, further comprising:
acquiring, based on the at least one relationship, a relationship between the search initiator and a labeling user associated with the matched label information, and a relationship between the search initiator and a labeled user associated with the matched label information; and
sending the acquired relationships to at least one of the search initiator or the labeled user associated with the matched label information.

12. A device for establishing a label library, comprising:
a processor; and
a non-transitory computer-readable storage medium storing instructions that, when executed by the processor, cause the processor to:
receive label information made by a labeling user regarding a labeled user in a social network;
store the labeling user, the labeled user, and the label information as a relationship; and
establish a label library based on the relationship.

13. The device according to claim 12, wherein the instructions further cause the processor to, before receiving the label information:
receive a first request sent from the labeled user for inviting the labeling user to label the labeled user; and
send a second request for labeling the labeled user to the labeling user.

14. The device according to claim 13, wherein:
the label information made by the labeling user regarding the labeled user is first label information,
the first request includes second label information made by the labeled user regarding the labeled user, and
the second request includes the second label information.

15. The device according to claim 12, wherein the instructions further cause the processor to, after receiving the label information:
judge whether the labeled user permits labeling; and
store the labeling user, the labeled user, and the label information as the relationship, and establish the label library, if the labeled user permits labeling.

16. The device according to claim 12, wherein the instructions further cause the processor to, after receiving the label information:
send the label information to the labeled user for confirmation;
judge whether a message indicating that the labeled user accepts the label information is received; and
store the labeling user, the labeled user, and the label information, and establish the label library, if the message is received.

17. The device according to claim 12, wherein the instructions further cause the processor to, after receiving the label information:
send the label information to the labeled user for supplementation;
receive supplemented label information sent by the labeled user; and
store the labeling user, the labeled user, and the supplemented label information as the relationship.

18. The device according to claim 12, wherein the instructions further cause the processor to:
acquire a validity period of the label information;
store the labeling user, the labeled user, the label information, and the validity period as the relationship; and
delete, when the label information expires according to the validity period, the labeling user, the labeled user, and the label information made from the label library.

19. A device for searching for a user, comprising:
a processor; and
a non-transitory computer-readable storage medium storing instructions that, when executed by the processor, cause the processor to:
receive a search request sent to a label library, the search request including a search initiator and a search keyword, and the label library includes at least one relationship, each of the at least one relationship including a labeling user, a labeled user, and label information made by the labeling user regarding the labeled user;
determine, based on the at least one relationship, at least one contact of a predetermined level of the search initiator;
search for matched label information matching the search keyword among label information in the label library that has the at least one contact as a labeling user; and
return the matched label information.

20. The device according to claim 19, wherein:
the search request is sent by the search initiator to the label library, and
the instructions further cause the processor to send information of a labeled user associated with the matched label information to the search initiator.

21. The device according to claim 19, wherein:
the search initiator is a labeled user associated with a piece of label information in the label library, and
the instructions further cause the processor to:
acquire the search keyword from the piece of label information; and
send the matched label information to at least one of the search initiator or a labeled user related to the matched label information.

22. The device according to claim 19, wherein the instructions further cause the processor to:
acquire, based on the at least one relationship, a relationship between the search initiator and a labeling user associated with the matched label information, and a relationship between the search initiator and a labeled user associated with the matched label information; and
send the acquired relationships to at least one of the search initiator or the labeled user associated with the matched label information.
